(19) United States
(12) Patent Application Publication
(10) Pub. No.: US 2026/0063749 A1
(43) Pub. Date: Mar. 5, 2026

(54) CALIBRATION OF REFLECTIVE SURFACE POSITIONING USING LIGHT BEAM ALIGNMENT TO DISTANT REFERENCE OBJECTS

(71) Applicant: William Quinn Marsh, Hemet, CA (US)

(72) Inventor: William Quinn Marsh, Hemet, CA (US)

(21) Appl. No.: 19/321,163

(22) Filed: Sep. 5, 2025

Related U.S. Application Data
(60) Provisional application No. 63/691,289, filed on Sep. 5, 2024.

(51) Int. Cl. G01S 3/78; F24S 50/20; G01S 3/786

(52) U.S. Cl. CPC G01S 3/7803; F24S 50/20; G01S 3/7861; G01S 3/7867; F24S 2050/25

(57) ABSTRACT

A system and method for calibrating reflective devices using reflected beam alignment with distant reference objects. The system comprises a reflective device with drives that orient a reflective surface, where drive states indicate the surface position. An incident beam from a beam emitter is directed at the reflective surface, creating a reflected beam observed against distant reference objects having known positions, such as stars. Calibration points are recorded comprising drive states corresponding to when the reflected beam aligns with reference objects. These calibration points are processed to optimize a computer model relating drive states to reflective surface orientation. The system may include cameras for capturing reflected beam images and a computing device for processing calibration data and modifying model parameters. The calibrated model enables precise control of reflective surface orientation, with particular application to heliostat calibration for solar power concentration, enabling accurate sun tracking during daylight operation after nighttime calibration.

This application claims the benefit of U.S. Provisional Application No. 63/691,289, filed Sep. 5, 2024, the entire disclosure of which is incorporated herein by reference, except where inconsistent with the present disclosure.

### FIELD OF THE DISCLOSURE

The present disclosure relates generally to optical alignment of devices and, more particularly, to systems and methods for determining device orientation by observing beams reflected from device surfaces against distant reference objects such as stars, with particular application to heliostat alignment.

### BACKGROUND

Precise optical alignment of devices is critical in various applications requiring accurate orientation control. Heliostats, which are devices that reflect sunlight toward predetermined targets, exemplify systems requiring high-precision alignment.

Heliostats typically require alignment accuracy of approximately 0.1 milliradians to effectively concentrate solar energy on receivers. This precision is challenging because heliostats operate through large ranges of motion and are often positioned far from their targets.

Existing alignment methods have various limitations including high equipment costs, requirements for preliminary site surveys, and limited operational ranges an inaccuracy the require frequent recalibration.

Accordingly, there is a need for improved alignment systems and methods that provide accurate, cost-effective calibration while maintaining operational efficiency.

### SUMMARY

A system comprises a reflective device having a drive configured to orient a reflective surface, where the drive has a drive state; information about a distant reference object having known positional information; and a recorded calibration point, where the calibration point comprises the drive state corresponding to when a reflected beam from the reflective surface is aligned relative to the distant reference object.

The reflected beam is generated by directing an incident beam from a beam emitter toward the reflective surface, and the reflected beam is the incident beam after reflecting off the reflective surface. The calibration point is used to reduce error in a computer model of the relationship between the drive state and the orientation of the reflective surface. The system may further comprise an image from a camera that shows the reflected beam, where the image is analyzed to determine alignment of the reflected beam relative to the distant reference object. The distant reference object may be a star. The incident beam direction and location may be known. The reflective device may be a heliostat configured for concentrating solar power.

A calibration system comprises a computing device that communicates information about a distant reference object having known positional information, receives a calibration point where the calibration point comprises a drive state when a beam reflected off a reflective surface is aligned relative to the distant reference object, and processes the calibration point to modify a model that relates drive state to reflective surface orientation. The computing device may comprise a display for communicating the information about the distant reference object and an input device for manually entering the calibration point. The system may further comprise an image that shows the reflected beam, where the image is analyzed to determine alignment of the reflected beam. The modification to the model may be a change to a parameter of the model. The distant reference object may be a star. The incident beam direction and location may be known. The model may enable a heliostat to track the sun during daylight operation.

A method comprises having information about a distant reference object having known positional information; recording an alignment of a reflected beam relative to the distant reference object, where the reflected beam is reflected off of a reflective surface, where the reflective surface has an associated drive and the drive has a drive state; and recording a calibration point comprising the drive state that corresponds to the alignment. The calibration point may be used to reduce error in a computer model of the relationship between the drive state and the orientation of the reflective surface. The computer model may enable the reflective surface to track the sun during daylight operation. The method may comprise analyzing an image from a camera that shows the reflected beam to determine alignment of the reflected beam relative to the distant reference object. A drive may move the reflective surface until the reflected beam is better aligned to the distant reference object. The distant reference object may be a star.

### BRIEF DESCRIPTION OF THE DRAWINGS

FIG. 1A: A calibration system for a heliostat collecting a calibration data point

FIG. 1B: A calibration system for a heliostat collecting a calibration data point with a wide beam and a focused reflective surface

FIG. 2: The calibration system for the heliostat in a different orientation collecting a second calibration data point

FIG. 3: A heliostat showing drives

FIG. 4: Calibration data

FIG. 5: Reflective computer model

FIG. 6: Calibration Process and Use

FIG. 7: A calibration system for communications equipment

FIG. 8: Heliostat calibration system configured to calibrate many heliostats

### DETAILED DESCRIPTION

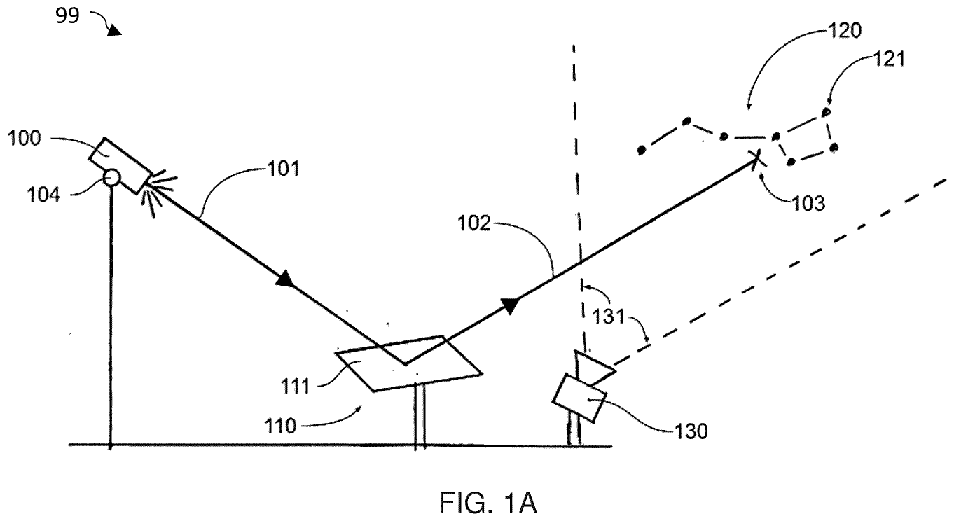

FIG. 1A illustrates a calibration system 99. The calibration system 99 includes a beam emitter 100 and a device 110 with a reflective surface 111. The beam emitter 100 generates and directs an incident beam 101 toward the reflective surface 111. The incident beam 101 is the portion of the beam emanating from the emitter 100 to the device 110. The reflected beam 102 is the portion of the beam that reflects off the reflective surface 111 and emanates into the sky 120, having an apparent endpoint 103 on the celestial sphere 120. The beam emitter 100 may be coupled to a mechanism 104 for moving or repositioning the emitter 100 as needed, or may be fixed in location during calibration. An observer 130 monitors the reflected beam 102 within a defined field of view 131, using distant reference objects 121 on the celestial sphere 120 as positional references to accurately determine the direction of the reflected beam 102. The distant reference objects 121 have known positions that can be observed and measured. This configuration enables precise characterization of the device's orientation through systematic observation and measurement of the reflected beam's apparent endpoint 103 relative to the known positions of the distant reference objects 121.

The beam emitter 100 may produce a laser beam. The beam emitter 100 may be any light source capable of producing a directed beam of light that can be reflected off the reflective surface 111 and observed against distant reference objects 121. The beam emitter 100 may produce a collimated beam with parallel rays. The beam emitter 100 may be a point source that diverges. The beam emitter 100 may produce a narrow focused beam for precise measurements at specific points on the reflective surface 111, or may produce a widened beam that reflects off a large portion of the reflective surface 111, the entire reflective surface 111, or multiple mirror facets simultaneously. The beam emitter 100 may create a wide beam using a beam spreader to maintain parallel rays.

The beam emitter 100 may be fixed in position during calibration, or may be connected to a powered rotation device 104 allowing the incident beam 101 to be directed at different heliostats devices 110 or different mirror facets. The beam emitter 100 may be mounted on a receiver tower, mounted to a stand-alone fixture near a heliostat 110 or group of heliostats, or mounted to part of the heliostat device 110 structure.

The beam emitter 100 is shown mounted on a stand-alone fixture near a heliostat device 110. The beam emitter 100 may be mounted to part of a heliostat's structure which may provide a line of site to a reflective surface 111 of a neighboring heliostat.

A beam, called an incident beam 101, emanates from the beam emitter 100 to the device 110. The incident beam 101 reflects off the reflective surface 111 producing the reflected beam 102.

When the reflected beam 102 traverses the atmosphere some of the light in the reflected beam is scattered by particles in the air, making the beam observable by the observer 130. The visible portion of the beam will extend for a great distance, sometimes dozens of kilometers, appearing to extend to infinity. Due to perspective, the reflected beam 102 to appear to have a fixed endpoint 103 on the celestial sphere 120. This is the same reason a laser pointer is useful in stargazing; when pointing a star out to a nearby friend, the laser will ‘point’ to the same star regardless of your friend's location.

Then the observer 130 may note if the direction of the reflected beam 102 is accurately observed by comparing the reflected beams apparent endpoint 103 with respect to the distant reference object 121. Using a star as a distant reference object 121 leverages large investments in research and technology in high-precision equipment from the astronomy community.

The observer 130 may be a camera or human operator or anything able to report on the reflected beam 102 alignment to the distant reference object 121. The observer 130 may also capture the incident beam 101 path from the emitter 100 to the reflective surface 111, enabling determination of both the incoming and outgoing beam directions for complete characterization of the device 110 orientation and alignment. The observer 130 observes the direction of the reflected beam 102 by comparing the reflected beam's apparent endpoint 103 with respect to a distant reference object 121. The observer 130 has an observer field of view 131 that captures both the reflected beam 102 and the distant reference object 121. When the observer 130 is a camera, it may be a digital imaging system that automatically records the reflected beam direction 723.

The observer 130 as a camera may be fixed and have a full 180° or 360° field of view so that it can see the entire celestial sphere 120. There may be multiple cameras 130 pointing in a variety of directions so that together they provide a full view of the celestial sphere 120. The camera 130 may use band pass filters to isolate the reflected beam 102 during daytime operations. In the primary configuration, a single observer 130 uses perspective to determine the three-dimensional direction of the reflected beam 102 from a two-dimensional image by observing the beam's apparent endpoint 103 on the celestial sphere 120 relative to the distant reference object 121.

Multiple cameras may be placed around a heliostat 110 or a group of heliostats 115 to observe the reflected beam 102 from different perspectives. When the apparent endpoint 103 cannot be observed directly-such as when it falls outside the camera's field of view 131, when atmospheric conditions limit beam visibility, or when using nearby reference objects like towers or terrain features-multiple cameras 130 can determine the beam's three-dimensional direction by observing the reflected beam 102 from different viewpoints relative to distant reference objects 121. The intersection of the beam observations from multiple perspectives establishes the true direction of the reflected beam 102 and helps counteract parallax error, which is the apparent shift in position of an object when viewed from different locations.

The observer 130 has an observer field of view 131. The observer 130 being a camera may be mounted on a moving mechanism allowing the camera to rotate so the observer field of view 131 can be moved to see different parts of the environment for example different parts of the night sky.

The celestial sphere 120 is a concept of a sphere that has an arbitrarily large radius and is concentric to Earth. All objects in the sky can be conceived as being projected on the inner surface of the celestial sphere 120, which is centered on the observer 130. When the distant reference object 121 is very far away, their coordinates on the celestial sphere 120 remain virtually constant even if the observer's 130 position on Earth changes slightly. This constancy is important to the allows the distant reference objects 121 to serve as highly accurate and stable reference points for determining the direction of the reflected beam 102.

The distant reference object 121 may be a star, planet, a terrain feature, a structure, a light, an aircraft, or spacecraft. Stars fill the entire sky and are available as reference points across the celestial sphere 120 at any time. Terrain features such as mountain peaks or man-made structures can provide reference points whose positional information can be known via GPS or survey. Lights may be mounted on terrain, structures, aircraft, or spacecraft to increase their visibility at a distance. Aircraft including unmanned aerial vehicles (UAVs) can have highly accurate positions known through GPS, while satellites and other spacecraft typically have highly defined orbital information.

The positions of stars within the night sky for any given location and time are extremely well known. The Hipparcos mission measured 100,000 stars with an accuracy of about 0.001 arcseconds, or about 4.8 nanoradians; about 20,000 times more accurate than the 0.1 milliradian typically required for heliostats. Contributing to lower costs, the use of stars and/or planets as reference points leverages billions of dollars and generations of investment in high-precision equipment by the astronomy community for free. Alternatively, the use of terrain or man-made objects as references can capitalize upon GPS information. Also note, no preliminary site surveying is required, further reducing costs. This is possible because this method makes efficient use of the calibration. All of this results in an extremely accurate long-lasting heliostat calibration and therefore higher efficiency, lower cost systems.

The reflective surface 111 may be a single continuous surface or may be made up of multiple discrete mirror facets. Multiple mirror facets can reduce manufacturing costs by reducing the size of raw material required. Heliostats 110 may have many discrete mirror facets that help with focusing by having each facet angled inward, forming an effective concave shape. The reflective surface 111 may incorporate focusing methods to concentrate light. The reflective surface 111 may have curved concave mirrors that help focus and concentrate light in a smaller solar image than if the reflective surface 111 was flat. The reflective surface 111 typically includes one or more mirror facets or one or more primary reflectors used for reflecting light in a desired direction. Each facet may be flat or may have a slight amount of curvature or concavity that causes the light to focus. The reflective surface 111 may have surface irregularities or waviness that can be characterized. When the reflective surface 111 has a focal distance and the beam emitter 100 is placed at that focal distance, diverging light from the beam emitter 100 can be collimated into parallel rays upon reflection. The reflective surface 111 is mounted on the device 110 and can be precisely oriented using the device's drives aim the reflected beam 102 toward a desired direction in the sky 120.

The calibration system enables a large range of reference objects for calibration. By calibrating over such a large range of motion, this method allows calibrations to be more accurate and last longer, for example weeks, months or even years, reducing the number of calibrations needed by a large factor for example 10, 100 or 1000 (or somewhere in that range) times less frequent.

With the beam reflecting off the reflective surface 111 this direct measurement of the reflective surface 111 increases the accuracy and reliability of the information gathered.

The position (location and orientation) of the reflective surface 111 for the device 110 may be characterized by a computer model. The computer model may be used to accurately predict the position of the reflective surface 111.

FIG. 1B: Illustrates a calibration system 199 where the beam emitter 100B emanates a wide incident beam 901 and the heliostat 110 has a focused reflective surface 912.

The wide beam 901 may come from a point source that diverges, like a spotlight, a laser with high beam divergence, a high-intensity discharge lamp, or other sufficiently bright light sources that naturally spread outward from a single emission point. The point source creates a cone of light that expands as it travels toward the reflective surface 912, illuminating a large area of the reflective surface.

The reflective surface 912 has focusing properties that collimate the diverging wide beam 901 into a parallel reflected beam 902. When the distance between the beam emitter 100B and the reflective surface 912 matches the focal distance of the reflector, the diverging incident beam 901 is transformed into parallel rays in the reflected beam 902. These parallel rays emanate into the sky 120 and appear to converge at a point 103 on the celestial sphere 120, making the beam easily observable against the night sky for calibration purposes.

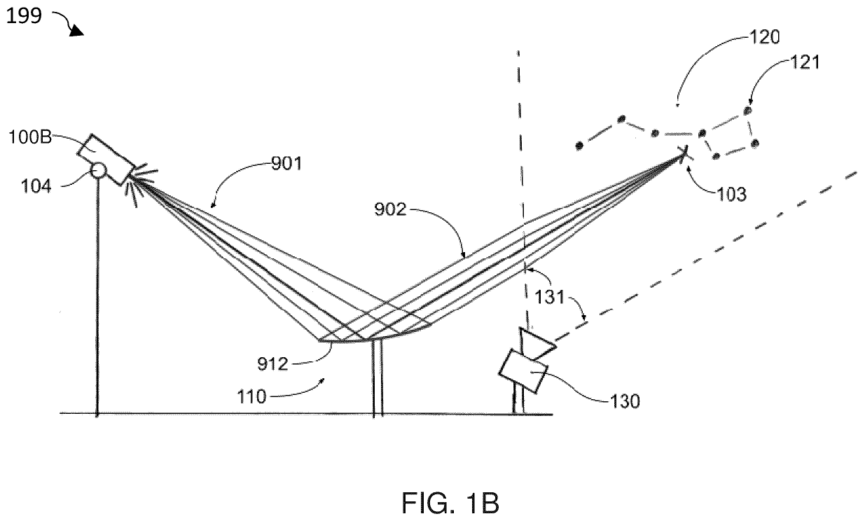

FIG. 2 illustrates the calibration system 99 collecting a subsequent calibration point with the reflective surface 111 rotated to a different orientation. The beam emitter 100 remains in the same fixed position, continuing to direct the incident beam 101 toward the reflective surface 111. However, the device 110 has used its drives to rotate the reflective surface 111 to a new orientation. This change in orientation causes the reflected beam 102 to emanate in a different direction across the sky 120, with its apparent endpoint 103 now positioned near another distant reference object 122 rather than the original reference object 121.

The observer 130 captures this new reflected beam direction relative to the other distant reference object 122. A calibration point consists of calibration data for example the observed direction of the reflected beam 102, and the drive states of the device 110 at that orientation. The process of repositioning the reflective surface 111 and recording calibration points may be repeated, with each new orientation providing another calibration point. Multiple calibration points (typically between 3 and 10) are collected across a variety of reflective surface orientations.

Calibration points can be captured quickly because observing the reflected beam's apparent endpoint 103 is a simple task for the observer 130. One limitation on collection speed is the time required for the device 110 to move the reflective surface 111 between orientations using its drives.

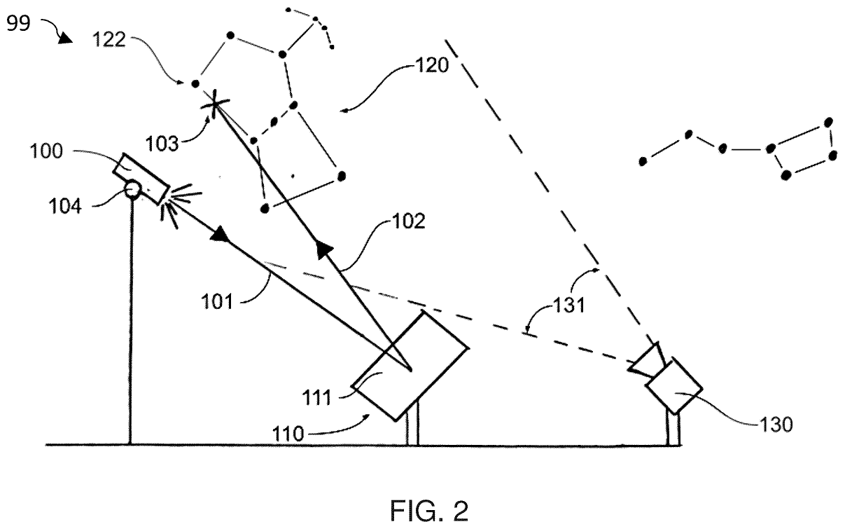

FIG. 3 illustrates a heliostat device 350 that serves as an exemplary implementation of the device 110 shown in FIGS. 1A, 1B, and 2. The heliostat 350 includes a base 352 that anchors the device to the ground or mounting surface. A main upright 354 extends vertically from the base 352, providing the primary structural support. A boom 356 connects to the main upright 354 at a horizontal pivot axis 358, allowing the boom 356 to pivot up and down relative to the main upright 354. The boom 356 extends outward and attaches to a mirror support structure 360 at a vertical pivot axis 364. The vertical pivot axis 364 enables the mirror support structure 360 to rotate left and right. A reflective surface 362 is mounted on the mirror support structure 360.

The heliostat 350 incorporates a drive system consisting of two motor drives that precisely control the orientation of the reflective surface 362. A vertical drive motor 366A operates a lead screw mechanism connected to a threaded pivot 368 attached to the boom 356. When activated, the vertical drive motor 366A rotates the lead screw, converting rotational motion into linear motion that changes the distance to the threaded pivot 368. This adjustment causes the boom 356 to pivot about the horizontal pivot axis 358, tilting the reflective surface 362 up and down to control its elevation angle. Similarly, a horizontal drive motor 366B operates a threaded screw 370 connected to the mirror support structure 360. Rotation of the horizontal drive motor 366B causes the threaded screw 370 to convert rotational motion into linear motion, rotating the mirror support structure 360 about the vertical pivot axis 364 to adjust the azimuth angle of the reflective surface 362.

Each motor drive (366A, 366B) has drive states that precisely indicate the current position and orientation of the reflective surface 362. The drive states provide quantitative data about the mechanical configuration of the heliostat 350 at any given moment, enabling precise correlation between the physical orientation of the reflective surface 362 and the observed direction of the reflected beam 102 on the celestial sphere 120.

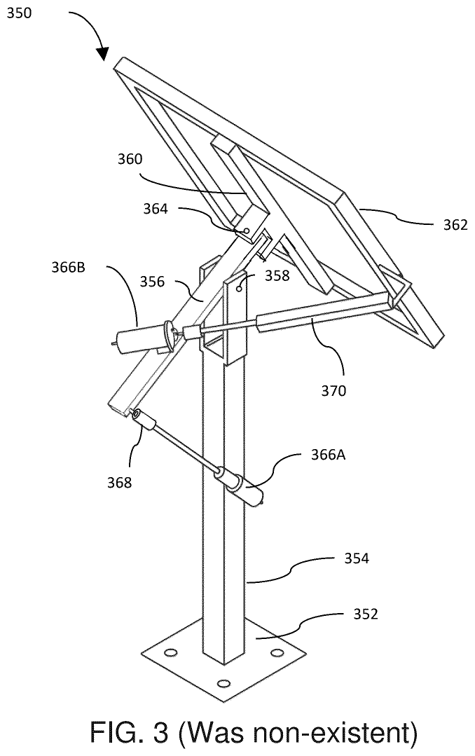

FIG. 4 illustrates the hierarchical structure of calibration data 720 collected with the reflective surface 111 in different positions. The calibration data 720 consists of multiple calibration points 721, with each calibration point 721 representing a complete observation at a specific reflective surface 111 position.

Each calibration point 721 is shown containing two pieces of data, 1) the drive states 722 and 2) a reflected beam direction 723.

The drive states 722 capture the precise mechanical configuration of the heliostat's drive system at the moment of observation, including all relevant position data from the drives, for example vertical drive motor 366A and the horizontal drive motor 366B. These drive states 722 may include encoder position readings that track the exact rotational position of each motor, cumulative motor movements recorded as step counts in stepper motor systems, indexer triggers that mark specific reference positions, limit switch activations that indicate travel endpoints, or other position feedback mechanisms

The reflected beam direction 723 records the observed direction of the reflected beam 102 as determined by the observer 130, specifically the position of the beam's apparent endpoint 103 on the celestial sphere 120 relative to distant reference objects, for example distant reference object 121 or other distant reference objects 122.

The correlation between drive states 722 and reflected beam direction 723 within each calibration point 721 establishes the fundamental relationship needed for calibration. When multiple calibration points 721 are collected at different reflective surface 111 orientations, they collectively form the calibration data 720. This complete dataset enables the calibration system to determine the precise relationship between the mechanical drive positions of the device 110 and the reflected beam 102 direction.

A sufficient collection of calibration points 721 (typically between 3 and 10) provides the calibration data 720 necessary to characterize the device 110 behavior across its range of motion. This calibration data 720 may be used to tune a kinematic computer model of the motion of the reflective surface 111, enabling accurate control of the reflective surface 111 orientation to direct reflected sunlight to a desired target during normal operation. The device 110 may be successfully calibrated when the computer model parameters derived from the calibration data 720 enable the device to maintain pointing accuracy within required tolerances (typically 0.1 milliradians) throughout its operational range.

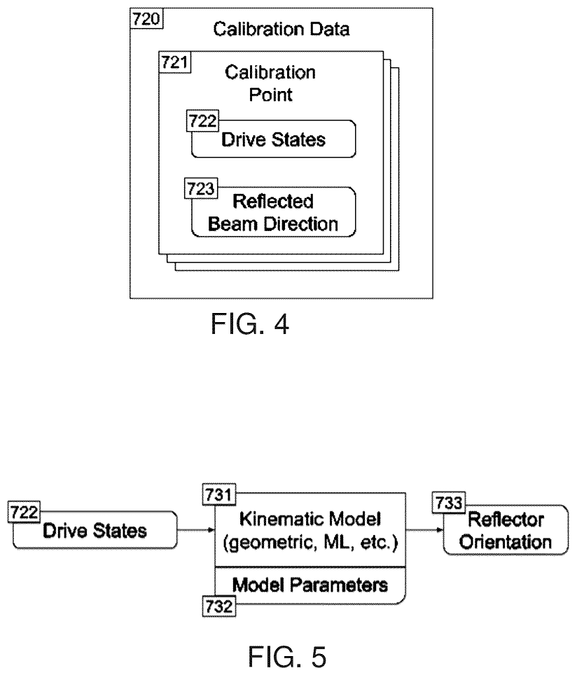

FIG. 5 illustrates a computer model 731 that transforms drive states 722 into a predicted reflector orientation 733 using model parameters 732. The computer model 731 serves as a computational representation of the device 110 mechanical system, enabling the calibration system to predict and control the precise orientation of the reflective surface 111.

The drive states 722 from the calibration points 721 serve as inputs to the computer model 731. The computer model 731 is any computational framework that correlates drive states 722 with reflector orientations 733. The model 731 may be implemented through various approaches including kinematic models based on geometric relationships, statistical models derived from empirical data, machine learning models trained on observed behaviors, lookup tables mapping drive positions to orientations, polynomial functions fitted to calibration data, or hybrid approaches combining multiple methodologies. The specific implementation of the computer model 731 is not critical to the invention; what matters is that the model 731 establishes a relationship between drive states 722 and reflector orientation 733 that can be calibrated using the calibration data 720.

The model parameters 732 are numerical values that the computer model 731 uses to accurately represent the specific device 110 being calibrated. These parameters may represent physical characteristics such as mechanical dimensions and alignment errors, mathematical coefficients in equations or polynomials, weights in neural networks, entries in lookup tables, or any other numerical values that the computer model 731 requires to transform drive states 722 into reflector orientations 733. The model parameters 732 are what may be adjusted during calibration to make the computer model 731 accurately represent the actual device 110.

The reflector orientation 733 represents the output of the computer model 731, for example a predicted angular orientation of the reflective surface 111. This predicted orientation 733 determines where the reflected beam 102 will be directed when light strikes the reflective surface 111. The reflector orientation 733 may be expressed in various coordinate systems, such as azimuth-elevation angles, Euler angles, rotation matrices, or quaternions.

The calibration data 720 may be used to determine more optimal model parameters 732. The calibration system may adjust the model for example the model parameters 732 so that the computer model 731 produces reflector orientations 733 more consistent with the observed reflected beam directions 723 in the calibration points 721.

The computer model 731 may operate bidirectionally to support both calibration and operational control. During calibration, the model 731 uses drive states 722 to predict reflector orientations 733 that can be validated against the reflected beam directions 723. During normal operation, the model 731 can operate in reverse to calculate the required drive states 722 needed to achieve a desired reflector orientation 733, enabling the device 110 to direct reflected sunlight to a specific target.

Once calibrated using the calibration data 720, the computer model 731 with its optimized model parameters 732 enables precise control of the device 110. The device 110 may be considered successfully calibrated when the computer model 731 accurately correlate drive states 722 and reflector orientations 733, maintaining pointing accuracy within required tolerances throughout the device's operational range of motion.

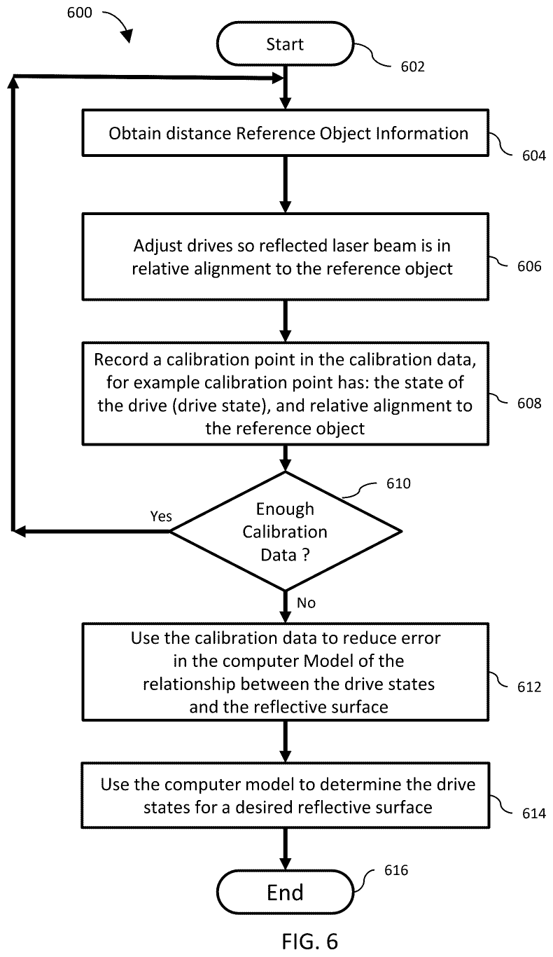

FIG. 6 shows a calibration method 600 for calibrating a heliostat 110 using distant reference objects 121. The method 600 begins at start step 602 and proceeds to step 604 where the system obtains distant reference object information. This information includes the positions of stars, planets, or other distant reference objects 121 that will be used as reference points for the calibration. The positions of these reference objects 121 may be obtained from astronomical databases, GPS coordinates for terrestrial features, or other sources that provide accurate positional data.

At step 606, the drives of the device 110 are adjusted to orient the reflective surface 111 so that the reflected beam 102 is in relative alignment to a reference object 121. This alignment positions the reflected beam 102 so it points toward or near a known reference object 121 on the celestial sphere 120, allowing the observer 130 to determine the precise direction of the reflected beam 102.

The calibration system may be implemented in various configurations to accomplish the drive adjustments. A complete single unit calibration system houses both the beam emitter 100 and a camera serving as the observer 130 in an integrated unit. This complete single unit calibration system may be mounted on a tripod and positioned near the device 110, with the beam emitter 100 manually aimed at the reflective surface 111 while the camera automatically captures the reflected beam 102 against the sky.

Alternatively, a single unit calibration system comprises the beam emitter 100 with a human serving as the observer 130. In this single unit calibration system, the human operator may use a smartphone app that identifies which distant reference objects 121 (such as specific stars) the reflected beam 102 should be aligned with next. The app may provide controls to adjust the device 110 drives and include a recording function (such as a “record alignment button”) that the operator activates when the reflected beam 102 is properly aligned with the identified reference object 121, capturing both the drive states 722 and the alignment at that moment.

At step 608, the system records a calibration point 721 in the calibration data 720. The reflected beam direction 723 is determined based on the position of the reflected beam 102 relative to the reference object 121.

At decision step 610, the system determines whether enough calibration data has been collected. If additional calibration points are needed (Yes branch), the method 600 returns to step 606 where the drives are adjusted to a new orientation and another calibration point is recorded. This loop continues until sufficient calibration data 720 has been collected, typically between 3 and 10 calibration points across various heliostat orientations. When enough calibration data has been collected (No branch), the method 600 proceeds to step 612.

At step 612, the system uses the calibration data 720 to reduce error in the computer model 731. This involves adjusting the model, for example adjusting model parameters 732 to minimize the difference between predicted reflector orientations 733 and the observed reflected beam directions 723. Other model adjustments may include switching between different model types (such as from a kinematic model to a machine learning model), adding or removing model components to account for observed behaviors, updating lookup tables with new empirical data, retraining neural network weights, or modifying the model structure to incorporate additional physical phenomena discovered during calibration.

At step 614, the calibrated computer model 731 is used to determine the drive states 722 needed to orient the reflective surface 111 to a desired position. With the accurate model parameters 732 established through calibration, the system can now precisely control the device 110 to track the sun and direct reflected light to a target. For Solar Power Concentration applications, performing calibration at night allows heliostats to generate power during the entire day. Night calibration also increases accuracy by avoiding daytime winds that can cause the reflective surface 111 to act as a sail. Alternatively, daylight calibration is possible using band pass filters to isolate the reflected beam 102 when distant reference objects 121 other than stars are visible. The method 600 then ends at step 616.

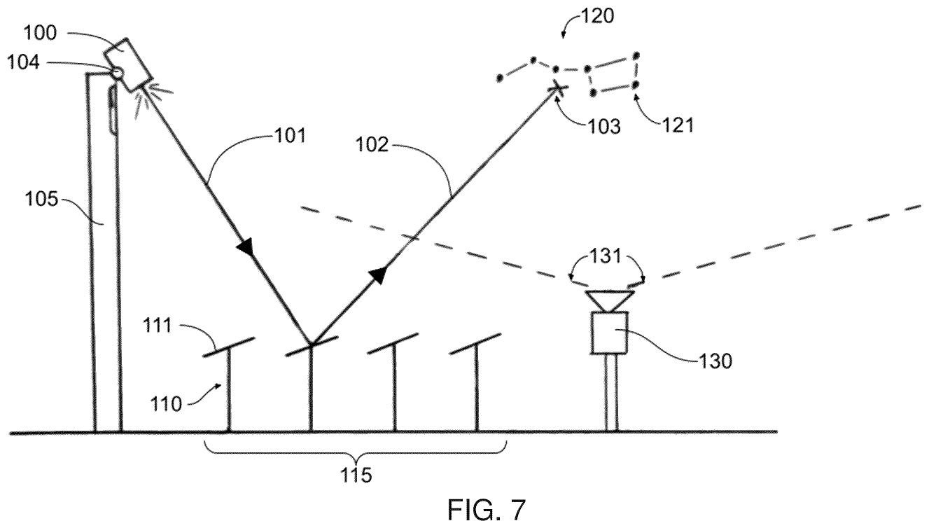

FIG. 7 illustrates the beam emitter 100 mounted on a solar collection tower 105, providing a convenient location where the beam emitter 100 has line of sight to many reflective surfaces 111 in the heliostat field 115.

Each heliostat device 110 may have a beam emitter 100 mounted near the heliostat device 110. The beam emitter 100 is aimed at the reflective surface 111 and fixed in place for the life of the site, providing consistent calibrations over time.

The beam emitter 100 may be connected to a motorized rotation device 104 that may be engaged to align the emitted beam 101 to aim at different reflective surfaces 111 of the heliostat devices 110. The beam emitter 100 and its rotation device could have preconfigured orientations for each heliostat device 110 set during initial installation of the heliostat device 110.

The beam emitter 100, the observer 130 as a camera and the heliostat device 110 may communicate to coordinate the beam emitter 100 direction, the camera direction or the reflective surface 111 direction for calibration. Communications and movement to the calibration direction may be automated.

The beam emitter 100 may be placed at the solar concentrated power receiver location at night and then aimed at each heliostat device 110. In this way, the incident beam 101 will match the solar target the heliostat devices track. This is advantageous because the direction of the incident beam 101 and thus the correct solar target direction is automatically determined during the calibration process.

The calibration system is shown in the context of a heliostat but the calibration system may be used in any field where precise orientation control of a reflective surface 111 is important, for example the alignment of communications equipment.

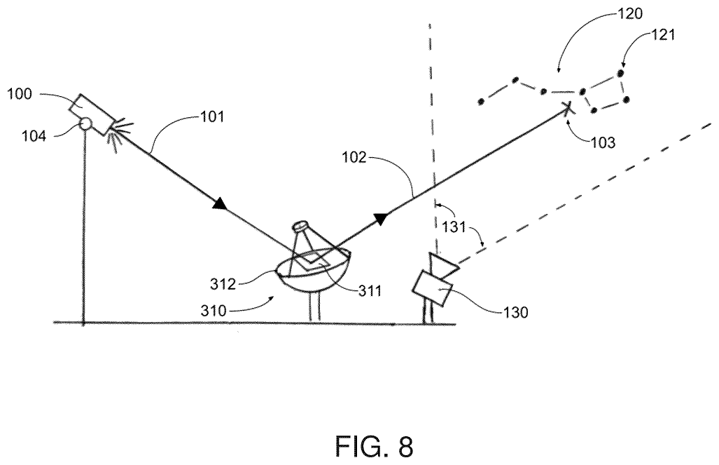

FIG. 8 illustrates a system 299 for aligning communications equipment 310. The communications equipment 310 includes a parabolic dish 312 with a reflective surface 311 mounted perpendicular to the directionality of the device. For example, a high gain antenna would have the reflective surface 311 mounted perpendicular to the direction of strongest emission or most sensitive reception. The calibration system can align the reflective surface 311 to calibrate the directionality of the communications equipment 310.

Multiple cameras may be placed around a heliostat device 110 or heliostat field 115 and simultaneously used to observe the apparent endpoint of the reflected beam 102. This could be useful in counteracting parallax error when determining the orientation of the beam. Parallax error occurs when either the reflected beam 102 endpoint or the distant reference objects aren't far enough away. This can occur for several reasons; distant reference objects could be relatively close such as a nearby tower, terrain or UAV. The reflected beam 102 endpoint may appear closer under certain atmospheric conditions.

The incident beam 101 may be moved via translation or rotation to ensure the incident beam 101 reflects off the same part of the reflective surface 111. This can be important for accuracy if the reflective surface 111 is not flat since each part of the reflective surface 111 may have a slightly different orientation.

The incident beam 101 may be widened so that the beam reflects off a large portion of the mirror facet, the entire mirror facet or many mirror facets. Using a wide beam reflecting off a large area can give a better representation of the reflective properties of the whole reflective surface.

The incident beam 101 may be widened using a beam spreader (so the rays are still parallel)

The incident beam 101 may be wide due to it being a point source that diverges, like a spotlight or a laser with high beam divergence.

The distance between the beam emitter 100 and the reflective surface 111 may be set to match the focal distance of the reflective surface 111 causing the reflected beam 102 to be a wide yet parallel reflective beam 102. The parallel rays should emanate into the sky, appearing to converge to a point on the celestial sphere making for easy observation against the night sky.

Multiple cameras may observe the same reflected beam 102 from different perspectives. The direction of the reflected beam 102 may be inferred in 3D space by comparing the apparent direction of the beam from each perspective against the distant reference objects. For example, images of the beam from different perspectives can be superimposed using computers to find the intersection of the beam from each perspective on the celestial sphere. The intersection on the celestial sphere with respect to distant reference objects is the true direction of the beam which can be used in calibration algorithms. This can be helpful if the visible portion of the beam is short.

A large beam that covers a large portion of the mirror facet may be used. The wide beam may be captured by a camera. Then using a radon algorithm or similar method, the surface shape or waviness can be resolved by looking at the dispersion of the reflected beam using multiple cameras at multiple angles using an algorithm like the radon algorithm.

To calibrate a heliostat that has a non-flat mirror or whose mirror is offset from the center of rotation, a fixed beam emitter 100 would reflect off different parts of the mirror with different normal vectors which would change the angle of the reflection. A translating beam emitter, multiple beam emitters, or a spread-out broad beam may be used.

The calibration system presented does not represent all possible embodiments of the principles taught by the present disclosure. The apparatus and methods described may be applied and adapted in alternative applications to provide precise characterization or control of the orientation, direction to, focus and surface irregularities.

1. A system comprising:
a reflective device having a drive configured to orient a reflective surface, where the drive has a drive state;
information about a distant reference object having known positional information; and
a recorded calibration point, where the calibration point comprises the drive state corresponding to when a reflected beam from the reflective surface is aligned relative to the distant reference object.

2. The system of claim 1, where the reflected beam is generated by directing an incident beam from a beam emitter toward the reflective surface, and the reflected beam is the incident beam after reflecting off the reflective surface.

3. The system of claim 1, where the calibration point is used to reduce error in a computer model of the relationship between the drive state and the orientation of the reflective surface.

4. The system of claim 1, further comprising:
an image from a camera that shows the reflected beam, where the image is analyzed to determine alignment of the reflected beam relative to the distant reference object.

5. The system of claim 1, where the distant reference object is a star.

6. The system of claim 1, where an incident beam direction and location are known.

7. The system of claim 1, where the reflective device is a heliostat configured for concentrating solar power.

8. A calibration system comprising:
a computing device that:
communicates information about a distant reference object having known positional information,
receives a calibration point where the calibration point comprises a drive state when a beam reflected off a reflective surface is aligned relative to the distant reference object, and
processes the calibration point to modify a computer model that relates drive state to reflective surface orientation.

9. The calibration system of claim 8, where the computing device comprises:
a display for communicating the information about the distant reference object; and
an input device for manually entering the calibration point.

10. The calibration system of claim 8, further comprising an image that shows the reflected beam, where the image is analyzed to determine alignment of the reflected beam.

11. The calibration system of claim 8, where the modification to the model is a change to a parameter of the model.

12. The calibration system of claim 8, where the distant reference object is a star.

13. The calibration system of claim 8, where an incident beam direction and location are known.

14. The calibration system of claim 8, where the model enables a heliostat to track the sun during daylight operation.

15. A method comprising:
having information about a distant reference object having known positional information;
recording an alignment of a reflected beam relative to the distance reference object,
where the reflected beam is reflected off of a reflective surface, where the reflective surface has an associated drive and the drive has a drive state; and
recording a calibration point comprising the drive state that corresponds to the alignment.

16. The method of claim 15, where the calibration point is used to reduce error in a computer model of the relationship between the drive state and the orientation of the reflective surface.

17. The method of claim 16, where the computer model enables the reflective surface to track the sun during daylight operation.

18. The method of claim 15, comprising analyzing an image from a camera that shows the reflected beam to determine alignment of the reflected beam relative to the distant reference object.

19. The method of claim 18, where a drive moves the reflective surface until the reflected beam is better aligned to the distant reference object.

20. The method of claim 15, where the distant reference object is a star.
